(19) United States
(12) Patent Application Publication
(10) Pub. No.: US 2013/0229288 A1
(43) Pub. Date: Sep. 5, 2013

(54) SERVER-SIDE INITIATED COMMUNICATION WITH ANALYTE METER-SIDE COMPLETED DATA TRANSFER

(71) Applicants: Stephen Alexander, Inverness (GB); Jon Lee-Davey, Portsmouth (GB); Graham Douglas, Moray (GB); Brian Guthrie, Inverness (GB); Allan Macrae, Inverness (GB); John Stewart, Edinburgh (GB)

(72) Inventors: Stephen Alexander, Inverness (GB); Jon Lee-Davey, Portsmouth (GB); Graham Douglas, Moray (GB); Brian Guthrie, Inverness (GB); Allan Macrae, Inverness (GB); John Stewart, Edinburgh (GB)

(73) Assignee: LifeScan Scotland Limited, Inverness-shire (GB)

(21) Appl. No.: 13/884,572

(22) PCT Filed: Nov. 14, 2011
(86) PCT No.: PCT/GB2011/001600

§ 371 Date: May 9, 2013

Related U.S. Application Data
(60) Provisional application No. 61/413,859, filed on Nov. 15, 2010.

(51) Int. Cl. G08C 15/06

(52) U.S. Cl. CPC G08C 15/06
USPC 340/870.02

(57) ABSTRACT

System and methods are provided to ameliorate a shortcoming identified by applicants for analyte meter in wireless communication to a server.

### PRIORITY

This application claims the benefits of priority under 35 USC§§119, 120, 365 or the Paris Convention for prior U.S. Provisional Patent Application Ser. No. 61/413,859 filed on Nov. 15, 2010, which application is hereby incorporated by reference in its entirety herein to this application.

### BACKGROUND

Analyte detection in physiological fluids, e.g. blood or blood derived products, is of ever increasing importance to today's society. Analyte detection assays find use in a variety of applications, including clinical laboratory testing, home testing, etc., where the results of such testing play a prominent role in diagnosis and management in a variety of disease conditions. Analytes of interest include glucose for diabetes management, cholesterol, ketone, and the like. In response to this growing importance of analyte detection, a variety of analyte detection protocols and devices for both clinical and home use have been developed.

One type of method that is employed for analyte detection is an electrochemical method. In such methods, an aqueous liquid sample is placed into a sample-receiving chamber in an electrochemical cell that includes two electrodes, e.g., a counter and working electrode. The analyte is allowed to react with a redox reagent to form an oxidizable (or reducible) substance in an amount corresponding to the analyte concentration. The quantity of the oxidizable (or reducible) substance present is then estimated electrochemically using an analyte meter specially configured to read the electrical signals related to the amount of analyte present in the initial sample.

Once the meter provides the analyte value or concentration to the patient, it is now up to the patient to self-management his or her diabetes. In the past few decades, the mode of self-management has been for the patient to record in a written or electronic logbook the glucose readings and other parameters (e.g., diet, exercise, drugs, psychological state, stress, and the like) that can be used by the patient with assistance from a health-care-provider (“HCP”) to manage the diabetes of the patient. Recently, many artisans in the art have developed smart logbook or even smartphones in connection with HCP's administered servers to help the patient keep track of analyte values and guide the patient through management of the diabetes. Others have also integrated certain components of the mobile phone and the meter to provide for a convenient integrated device. Problems, however, remain for seamless and low cost implementation of data transfer between the patient and the HCP's servers.

### SUMMARY OF THE DISCLOSURE

Applicants have identified a shortcoming with the communication scheme of meter in wireless communication to a server in that scheduled communication intervals for the meter to communicate to the server may cause urgent messages or critical data from the server to be missed by the patient using the meter. By identification of this shortcoming, applicants have provided with several approaches to ameliorate or even eliminate this shortcoming.

In one embodiment, a chronic disease management system is provided that includes an analyte meter and a server. The analyte meter has a display, interface buttons and a mobile communication module disposed in a unitary housing. The server is bi-directionally coupled to the analyte meter via one of multiple wireless communication mediums or protocols such that the server is configured to contact the mobile communication module in one wireless medium in preparation for the meter to initiate a contact with the server and transfer data stored in the meter in a different wireless communication medium.

In yet another embodiment, a chronic disease management system is provided that includes an analyte meter and a server. The analyte meter has a display, interface buttons and a mobile communication module disposed in a unitary housing. The server is server bi-directionally coupled to the analyte meter via a wireless communication mediums such that the server is configured to contact the mobile communication module in one wireless medium in preparation for the meter to initiate a contact with the server and transfer data stored in the meter in the same medium, protocol, or standard.

In yet a further embodiment, a method of communication for a server wirelessly connected to an analyte meter having a mobile communication module coupled to a microprocessor is provided. The method can be achieved by: causing the server to contact the communication module in one wireless communication protocol with a query signal; confirming receipt of the query signal by the communication module; disallowing or preventing the communication module from opening a communication channel; and contacting the server by communication module with a different communication protocol.

These and other embodiments, features and advantages will become apparent to those skilled in the art when taken with reference to the following more detailed description of various exemplary embodiments of the invention in conjunction with the accompanying drawings that are first briefly described.

### BRIEF DESCRIPTION OF THE FIGURES

The accompanying drawings, which are incorporated herein and constitute part of this specification, illustrate presently preferred embodiments of the invention, and, together with the general description given above and the detailed description given below, serve to explain features of the invention (wherein like numerals represent like elements).

FIG. 1 illustrates a high level functional block diagram of a representative network-based system.

FIG. 2 illustrates an exemplary blood-glucose meter configured to have a mobile communication module integrated therein.

FIG. 3A illustrates one side of an exemplary PCB board for the meter of FIG. 2.

FIG. 3B illustrates another side of the exemplary PCB board (or a separate PCB board) for the meter of FIG. 2.

FIG. 4 illustrates a logic diagram for a server-initiated, meter-completed communication via a rejected call technique.

FIG. 5 illustrates a logic diagram for a server-initiated, meter-completed communication technique using SMS.

### DETAILED DESCRIPTION OF THE EXEMPLARY FIGURES

The following detailed description should be read with reference to the drawings, in which like elements in different drawings are identically numbered. The drawings, which are not necessarily to scale, depict selected embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention.

As used herein, the terms “about” or “approximately” for any numerical values or ranges indicate a suitable dimensional tolerance that allows the part or collection of components to function for its intended purpose as described herein. In addition, as used herein, the terms “patient,” “host,” “user,” and “subject” refer to any human or animal subject and are not intended to limit the systems or methods to human use, although use of the subject invention in a human patient represents a preferred embodiment.

The subject methods or system can be used, in principle, with any type of electrochemical cell having spaced apart first and second electrodes and a reagent layer. For example, an electrochemical cell can be in the form of a test strip. in one aspect, the test strip may include two opposing electrodes separated by a thin spacer for defining a sample-receiving chamber or zone in which a reagent layer is located. One skilled in the art will appreciate that other types of test strips, including, for example, test strips with co-planar electrodes may also be used with the methods described herein. Details of the preferred test strip are provided in U.S. Pat. Nos. 5,708,247; 5,951,836; 6,241,862; and 7,112,265, all of which are incorporated by reference in their entireties herein. Another alternative test strip that may be utilized are shown, described, and claimed in U.S. Pat. Nos. 6,193,873; 6,872,298; 6,179,979; 6,284,125; 7,045,046; and 7,498,132, all of which are incorporated by reference in their entireties herein.

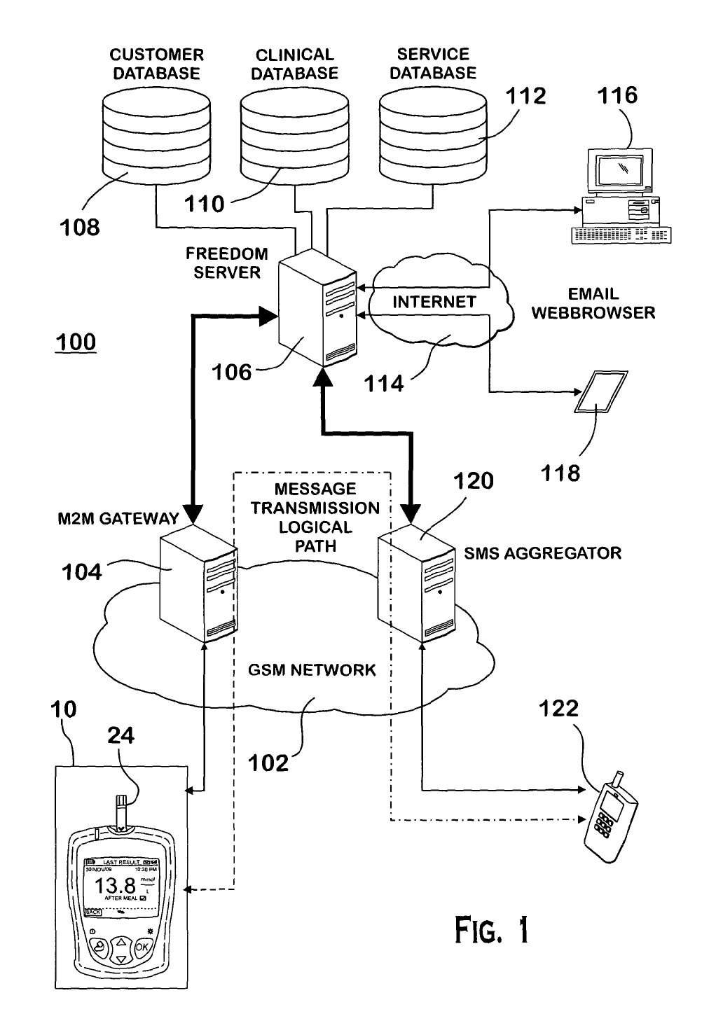

FIG. 1 illustrates a diabetes management system 100 that includes a diabetes data management unit 10 and a biosensor in the form of a glucose test strip 24. Note that the diabetes data management unit (DMU) 10 may be referred to as an analyte measurement and management unit, a glucose meter, a meter, or an analyte measurement device. In an embodiment, the DMU 10 may be combined with an insulin delivery device, an additional analyte testing device, and a drug delivery device. The DMU may be connected via a communication module 46 to the computer 116 or server 106 via a cable or a suitable wireless technology such as, for example, GSM, GPRS, 3G, 4G, WCDMA, LTE, BlueTooth, Wi-Fi and the like.

The system 100 includes a mobile communication network, illustrated exemplarily as a GSM or GPRS network in which a machine-to-machine gateway 104 is provided for the DMU 10 to connect with a preferably secure server 106. The exemplary network may be a standard 2G/2.5G/Edge network that is available in most countries around the world. Standard machine-to-machine (M2M) techniques are used to provide the data connections to the DMUs 10. Secure server 106 is in communication with multiple databases such as, for example, customer database 108, clinical database 110, or service database 112. The server 106 is configured to be in communication with the patient, other caregivers, caretakers, HCP, or health coaches via the internet 114 and suitable devices such as a personal computer 116, or smartphone 118. The system 100 also includes a Short-Message-Services server 120 to allow for transmission and receipt of data via SMS or e-mail by remote caregiver via other mobile phones 122.

In the preferred embodiment, there are two options for connecting the server 106 to the telecom provider's mobile network 102. One option includes having a connection gateway provided between the mobile network and company network to which the server is connected. This supports a VPN connection between the mobile device and the company network. The gateway is able to provide user name/password validation before allowing a connection. This is also known as a Private APN. The other option includes having the server connected to a public network (e.g., the Internet). The mobile network has a gateway to the Internet and will then route the connection through the gateway to the Internet and on to the server 106. This solution allows other users with Internet access to also access the server 106. This is also known as a Public APN.

The DMU 10 may connect to the server by a private APN by instructing the module 46 to register with the telecom mobile network 102 which will use DHCP to allocate dynamic IP address to the communication module 46 in the DMU 10. The DMU 10 then tries to connect to the gateway (e.g., Private APN). The gateway is identified by a URL. The user name/password of the DMU 10 can be validated and if required, a VPN connection established (this is security between the DMU 10 and the company network). When connected the DMU 10 then establishes a connection through to the server 106. Once connection is achieved, end to end authentication and message privacy can be resolved between the DMU 10 and the server 106. A data exchange can then take place. This will be one or more application messages in each direction and will reply on TCP/IP to carry them and confirm their receipt.

Alternatively, the DMU may make a connection via a Public APN in which the DMU 10 application instructs the communication module 46 to register with the telecom provider's mobile network. This will use DHCP to allocate a dynamic IP address to the communication module 46 within DMU 10. When connected the DMU 10 then establishes a connection through to the server 106. Once connection is achieved, authentication and message privacy can be resolved between the DMU 10 and the server 106. A data exchange can then take place. This will be one or more application messages in each direction and will reply on TCP/IP to carry them and confirm their receipt.

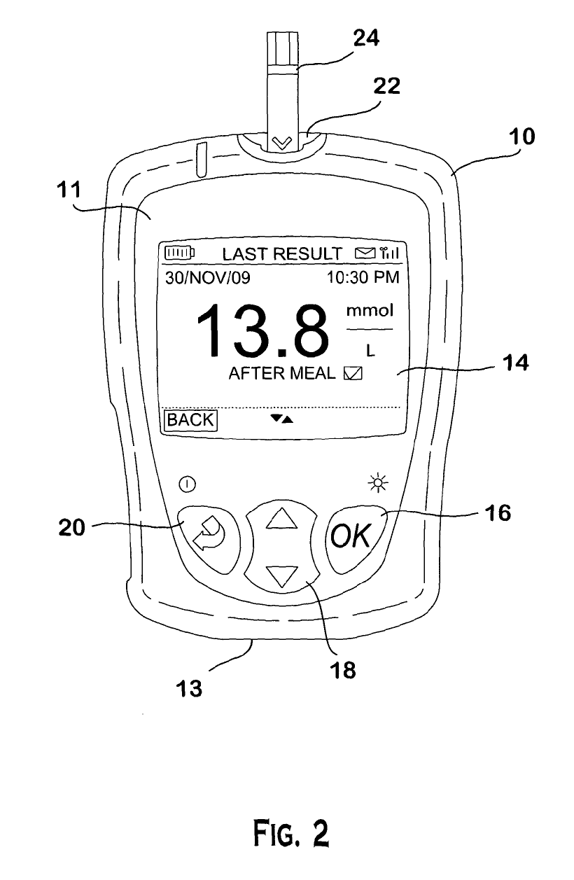

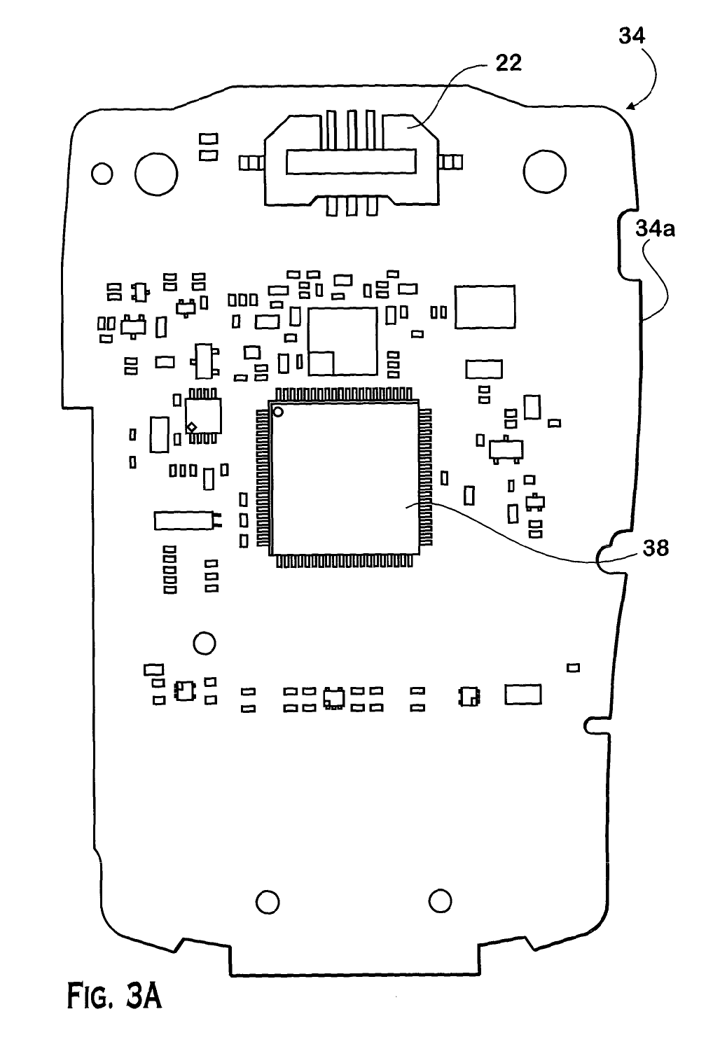

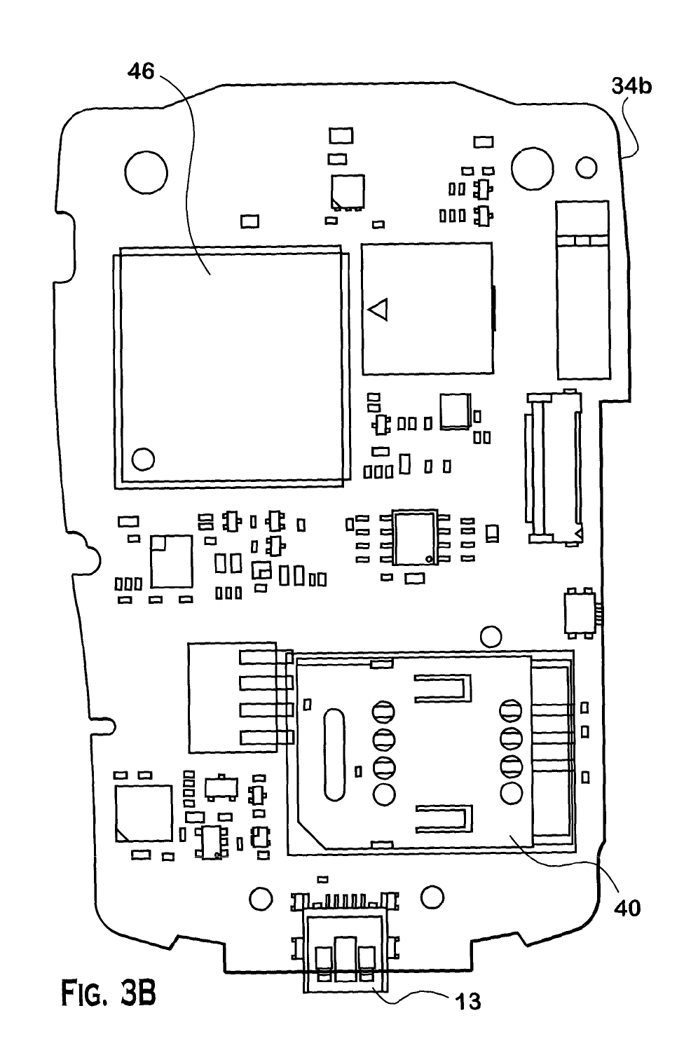

The DMU 10, shown in FIG. 2, includes a display 14, interface buttons 16, 18, 20, and a mobile communication module 46 (FIG. 3B) disposed in a unitary housing 11. A server 106 is bi-directionally coupled to the DMU 10 via one of multiple wireless communication mediums, standards, or protocols (e.g., GSM, EDGE, GPRS, 3G, 4G, Wi-Fi) such that the server is configured to contact the mobile communication module 46 in one wireless medium in preparation for the DMU 10 to initiate a contact with the server and transfer data stored in the meter in a different wireless communication medium. Alternatively, a server is bi-directionally coupled to the analyte meter via a wireless communication mediums such that the server is configured to contact the mobile communication module in one wireless medium in preparation for the meter to initiate a contact with the server and transfer data stored in the meter in the same medium, protocol, or standard. It should be noted that the wireless can be by a suitable scheme such as, for example, frequency-division-multiple-access (FDMA), time-division-multiple-access (TDMA), code-division-multiple-access (CDMA), space-division-multiple-access (SDMA), and orthogonal frequency-multiple-access (OFMA). It should be noted that the DMU 10 is not limited to an interface requiring interface buttons and may be utilized with only one button, no button, or a touch-screen interface that does not have mechanical buttons or switches.

Referring to FIG. 2, DMU 10 can include a strip port opening 22 and data port 13. User interface buttons (16, 18, and 20) can be configured to allow the entry of data, navigation of menus, and execution of commands. User interface button 18 can be in the form of a two way toggle switch. Data can include values representative of analyte concentration, and/or information, which are related to the everyday lifestyle of an individual. Information, which is related to the everyday lifestyle, can include food intake, medication use, occurrence of health check-ups, and general health condition and exercise levels of an individual. The DMU 10 is preferably configured to display the following: History of last 10 messages; Connection status; Connection strength; Connection count, duration and data volumes; View last connection/error details; Time of day; Battery life; Selection of flight and holiday modes and inputs including Message read acknowledgement

The electronic components of DMU 10 can be disposed on a circuit board 34 that is within housing 11. FIG. 3A illustrates (in simplified schematic form) the electronic components disposed on a top surface of circuit board 34. On one side 34a, the electronic components may include a strip port connector 22, a microcontroller 38, a non-volatile flash memory, a data port 13, clock, and a plurality of operational amplifiers. On the other board 34b or an opposite surface 34b, the electronic components may include a communication module 46, SIMS card 40, a backlight driver, and an electrically erasable programmable read-only memory (EEPROM, not shown). In the preferred embodiment, the communication module 46 may be a GE86X module from Telit Communications S.p.A. While the communication module 46 and the microcontroller 38 are illustrated exemplarily as separate modules, both modules can be integrated into a unitary module.

Microcontroller 38 can be electrically connected to strip port opening 22, non-volatile flash memory, communication module 46, data port 13, real time clock, the plurality of operational amplifiers, the plurality of analog switches, the backlight driver, and the EEPROM.

Microcontroller 38 can be in the form of a mixed signal microprocessor (MSP) such as, for example, the Texas Instrument MSP 430. The MSP 430 can be configured to also perform a portion of the potentiostat function and the current measurement function. In addition, the MSP 430 can also include volatile and non-volatile memory. In another embodiment, many of the electronic components can be integrated with the microcontroller in the form of an application specific integrated circuit (ASIC).

Display 14 can be in the form of a liquid crystal display for reporting measured glucose levels, and for facilitating entry of lifestyle related information. Display 14 can optionally include a backlight. Data port 13 can accept a suitable connector attached to a connecting lead, thereby allowing DMU 10 to be linked to an external device such as a personal computer. Data port 13 can be any port that allows for transmission of data such as, for example, a serial, USB, or a parallel port.

The DMU 10 is provided with an inbuilt process for initiating a connection to the secure server 106 whenever it has data to upload to the server 106. Once a connection has been established, the server 106 is able to download messages from a health care provider or health coach (“HC”) to the DMU 10. However, some HC messages that the server receives maybe more urgent than others. As a result the polling cycle used by the DMU 10 might delay receipt of these urgent messages by the patient. Therefore, if the server 106 initiated the connection between it and the DMUs 10 this would help improve the turnaround of messages.

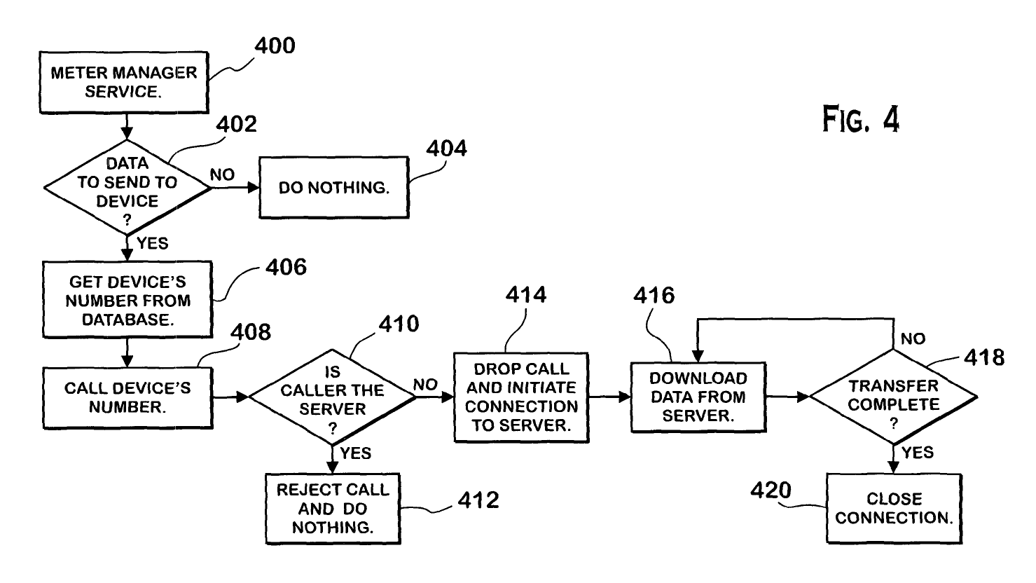

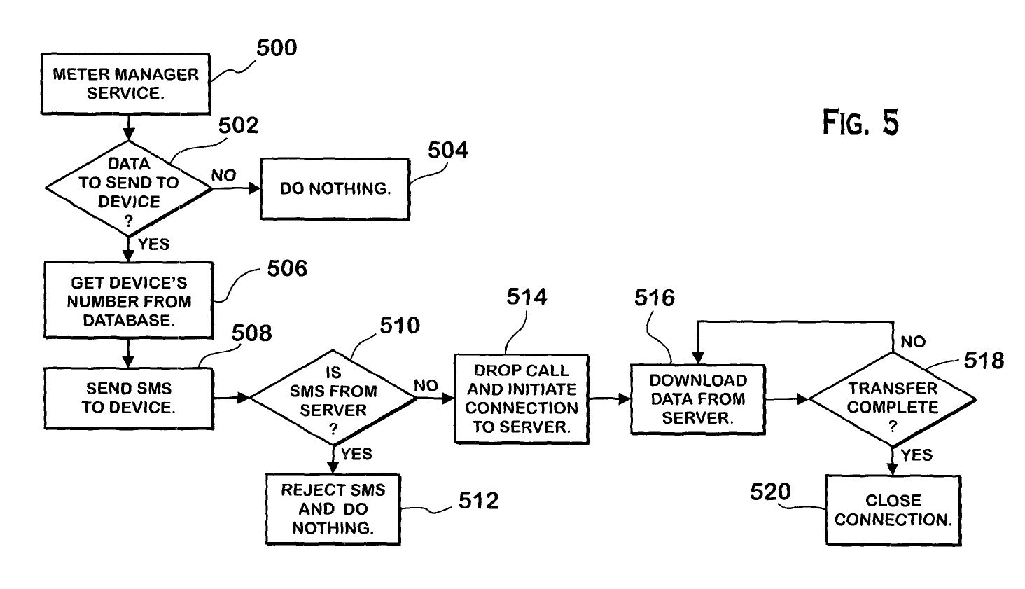

Specifically, communications are initiated by a DMU 10 after a user has taken a blood glucose test or after a configurable polling period. However, there are a number of methods which can be utilized to allow the server to trigger the DMU 10 to make a connection when the server has data. These methods are shown and described in relation to FIGS. 4 and 5.

Referring to FIG. 4, certain SIM cards provide the DMU 10 with a mobile phone number. Normally, if the DMU 10 receives a phone call from an unknown source it will reject the call. However, if the DMU 10 received a call from the server 106 it could be configured to reject the call. As the call is rejected by the MU 10, the server would not be charged for this call. But the DMU 10 would then attempt to connect to the server via GSM for transfer of data. In particular, the method can be achieved, shown here in FIG. 4, by a routine of a data manager 400. In step 402, if the manager 400 determines that there are data to be sent to a specified DMU 10, the manager 400 obtains the phone number of the specified DMU 10 from a database in step 406. The manager 400 then causes the server to contact the communication module in one wireless communication protocol with a query signal at step 408. The DMU 10 then confirms receipt of the query signal by the communication module 46 in the DMU 10 at step 410. The communication module 46 is disallowed from opening a communication channel and the call is dropped in step 414 and the DMU 10 initiates contact with the server 106 by communication module 46 with a different communication protocol. Once all the data are downloaded in steps 416-418, the connection is closed.

Referring to FIG. 5, the manager 400 routine could initiate (via steps 502, 504, 506, and 508) a connection from the server 106 to the DMU 10 by having the server 106 sending the DMU 10 an SMS message in step 508. The DMU 10 could be configured such that the DMU 10 would recognize the SMS as originating from the server in step 510. If the SMS is not from the server then the DMU 10 would reject the SMS and do nothing in step 512. If the SMS is from the server 106 then the DMU 10 would initiate a connection to the server in step 514, download data from the server 106 in step 516, and close the connection in steps 518 and 520. It should be noted that the system is not limited to text messages sent to mobile phones or communication module and that the system also sends/receives SMS messages via email and a web interface.

As noted earlier, the microcontroller can be programmed to generally carry out the steps of various processes described herein. The microcontroller and communication module can be part of a particular device, such as, for example, a glucose meter, an insulin pen, or an insulin pump. Furthermore, the various methods described herein can be used to generate software codes using off-the-shelf software development tools such as, for example, C or variants of C such as, for example, C+, C++, or C-Sharp. The methods, however, may be transformed into other software languages depending on the requirements and the availability of new software languages for coding the methods. Additionally, the various methods described, once transformed into suitable software codes, may be embodied in any computer-readable storage medium that, when executed by a suitable microcontroller or computer, are operable to carry out the steps described in these methods along with any other necessary steps.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. Therefore, to the extent there are variations of the invention, which are within the spirit of the disclosure or equivalent to the inventions found in the claims, it is the intent that this patent will cover those variations as well.

What is claimed is:

1. A chronic disease management system comprising:
an analyte meter having a display, interface buttons and a mobile communication module disposed in a unitary housing; and
a server bi-directionally coupled to the analyte meter via one of multiple wireless communication mediums such that the server is configured to contact the mobile communication module in one wireless medium in preparation for the meter to initiate a contact with the server and transfer data stored in the meter in a different wireless communication medium.

2. A chronic disease management system comprising:
an analyte meter having a display, interface buttons and a mobile communication module disposed in a unitary housing; and
a server bi-directionally coupled to the analyte meter via a wireless communication mediums such that the server is configured to contact the mobile communication module in one wireless medium in preparation for the meter to initiate a contact with the server and transfer data stored in the meter in the same medium, protocol, or standard.

3. A method of communication for a server wirelessly connected to an analyte meter having a mobile communication module coupled to a microprocessor, the method comprising:
causing the server to contact the communication module in one wireless communication protocol with a query signal;
confirming receipt of the query signal by the communication module;
preventing the communication module from opening a communication channel with the server; and
separately contacting the server by communication module with a different communication protocol.

4. The system of one of claim 1 or claim 2, in which the meter comprises a microprocessor in communication with the communication module, memory, power supply, and a strip port connector.

5. The system of one of claim 1 or claim 2, in which the communication module is selected from a group of modules consisting essentially of GSM, EDGE, GPRS, 3GUMTS, 4G modules and combination thereof.

6. The system of one of claim 1 or claim 2, in which the communication module comprises a GSM/GPRS module.

7. The system of one of claim 1 or claim 2, in which the server is configured to transmit in accordance with at least one of a GSM, EDGE, GPRS, 3GUMTS, and 4G protocols.

8. The method of claim 7, in which the causing comprises the server obtaining an identifier for a selected meter and the disallowing comprises determining whether the query signal came from the server and if true, initiating a connection to the server, downloading data from the server and closing the connection when the downloading is completed.

9. A method of communication for a server wirelessly connected to an analyte meter having a mobile communication module coupled to a microprocessor, the method comprising:
obtaining an identifier for the meter;
sending a short-message-service (“SMS”) to the meter with the identifier; and
identifying that the SMS is from an acceptable server, initiating a separate connection from the meter to the server, downloading data from the server and closing the connection.
